(19) United States
(12) Patent Application Publication
(10) Pub. No.: US 2016/0245461 A1
(43) Pub. Date: Aug. 25, 2016

(54) Glowing Cover System

(71) Applicant: Phyllis Stoute, Brooklyn, NY (US)

(72) Inventor: Phyllis Stoute, Brooklyn, NY (US)

(21) Appl. No.: 15/051,236

(22) Filed: Feb. 23, 2016

Related U.S. Application Data
(60) Provisional application No. 62/119,509, filed on Feb. 23, 2015.

(51) Int. Cl. F21K 2/00

(52) U.S. Cl. CPC F21K 2/00

(57) ABSTRACT

A glowing cover system for illuminating an object is provided. The glowing cover system comprises a cover capable of being positioned over at least a portion of the object with an amount of phosphors associated with in the cover. Upon energizing the phosphors, the phosphors radiate visible light causing the cover to glow.

### CLAIM OF PRIORITY

This patent application claims priority under 35 USC 119 (e) (1) from U.S. Provisional Patent Application Ser. No. 62/119,509 filed Feb. 23, 2015, of common inventorship herewith entitled, “Glow Finder,” which is incorporated herein by reference as though the same were set forth in its entirety.

### FIELD OF THE INVENTION

The present invention pertains to the field of cover accessories, and more specifically to the field of key covers, key rings and cell phone covers.

### BACKGROUND OF THE INVENTION

Since hectic and busy days are becoming more and more common in today's fast paced world, distractions are almost impossible to avoid, even in the household. Whether the telephone is ringing incessantly, children are insistent with demands or breakfast is about to burn on the stove, it is quite simple to lose track of personal items when having to attend to so many tasks. Purses and wallets, medications, eyeglasses, and especially keys are seemingly sucked into some unknown abyss as on the go living stretches one's attention astray. When things have calmed, many face an extended search for necessary keys, entirely unsure of where they possibly left them. Whether slipped between chair cushions or absently placed in another room, locating these objects is extremely aggravating and time consuming, especially when running late for work or school.

The prior art has put forth several designs for key covers, key rings and cell phone covers. Among these are:

US Patent 2013/0260835 to Matthew C. Sikora and Matthew S. Burns describes an electronics case for a portable electronic device with an electroluminescent or ELP panel for displaying light patterns in response to sound, vibration or other input signals. The case includes an integrated control circuit for receiving input signals from an input device and, in response, generating a set of ELP pattern signals that are transmitted to the ELP. The integrated control circuit also includes a power supply connected to the controller for supplying power to the integrated control circuit and the ELP. The ELP comprises a plurality of segments and it is affixed to the exterior surface of the case to attract attention to the light patterns as they are being displayed on the ELP.

US Patent 2008/0096461 to Donata M. Barnas and Marcelle N. Barnas describes toys and other fabric coated articles that glow in the dark. The present invention is preferably directed to a variety of articles, especially stuffed toys, that exhibit luminescence in the dark following light exposure. The toys may be any variety of animal, plant or specific form, including but not limited to mammals, reptiles, birds and insects. Methods of manufacture are described that use fabric coated with luminescent material on one side that is used as casings with the rough coating side facing inwardly for toys and other items.

US Patent 2008/0142129 to Timothy Reasner, Lorraine M. Stevens and Eric Stevens describes a protective cover for a vehicle remote control device. The cover comprises a housing and a plurality of buttons on the surface of the housing which are pressed for activating predetermined vehicle functions. The protective cover comprises an inner plastic sheath for fittingly surrounding the housing, the inner plastic sheath being comprised a relatively soft and pliable plastic material and having an opening therein through which the remote control device is inserted. An outer sheath substantially surrounds the inner plastic sheath. The outer sheath is comprised of a material selected for its ability to protect the remote control device. The outer sheath has an opening therein which substantially corresponds to the opening in the inner plastic sheath, and has at least one window therein, the window being located on the outer sheath so that the buttons are viewable through the window when the remote control device is inserted in the protective cover.

US Patent 2006/0172765 to Yosef Lev describes a decorative carrying case for mobile telephones, personal digital assistants or PDAs, cameras, and other portable electronic devices. The said case incorporates outwardly visible reservoirs of cohesive gel therein for a striking aesthetic effect, and discrete ornaments float in the gel to pronounce the effect. The gel reservoirs also provide padding and insulation to protect the mobile phone while providing a useful and unique aesthetic structure.

None of these prior art references describe the present invention.

### SUMMARY OF THE INVENTION

It is an object of the present invention to provide a uniquely configured external covering that provides glow in the dark capabilities on key covers, key rings and cell phones.

The present invention is a glowing cover system for illuminating an object. The glowing cover system comprises a cover capable of being positioned over at least a portion of the object with an amount of phosphors associated with in the cover. Upon energizing the phosphors, the phosphors radiate visible light causing the cover to glow.

In addition, the present invention includes a method for illuminating an object. The method comprises providing a cover, positioning at least a portion of the cover over the object, associating an amount of phosphors with in the cover energizing the phosphors, and radiating visible light from the phosphors causing the cover to glow.

The present invention further includes a glowing cover system for illuminating an object. The glowing cover system comprises a cover capable of being positioned over at least a portion of the object and an amount of phosphors associated with in the cover. Upon energizing the phosphors, the phosphors radiate visible light causing the cover to glow in a variety of colors with the energized phosphors provide a visual beacon for quickly locating the object.

### BRIEF DESCRIPTION OF THE DRAWINGS

FIG. 1 is a top perspective view illustrating a glowing cell phone cover with glow in the dark luminescent qualities.

FIG. 2 is a top perspective view illustrating an individual key cover with glow in the dark luminescent qualities.

FIG. 3 is a perspective view illustrating a key ring with glow in the dark luminescent qualities

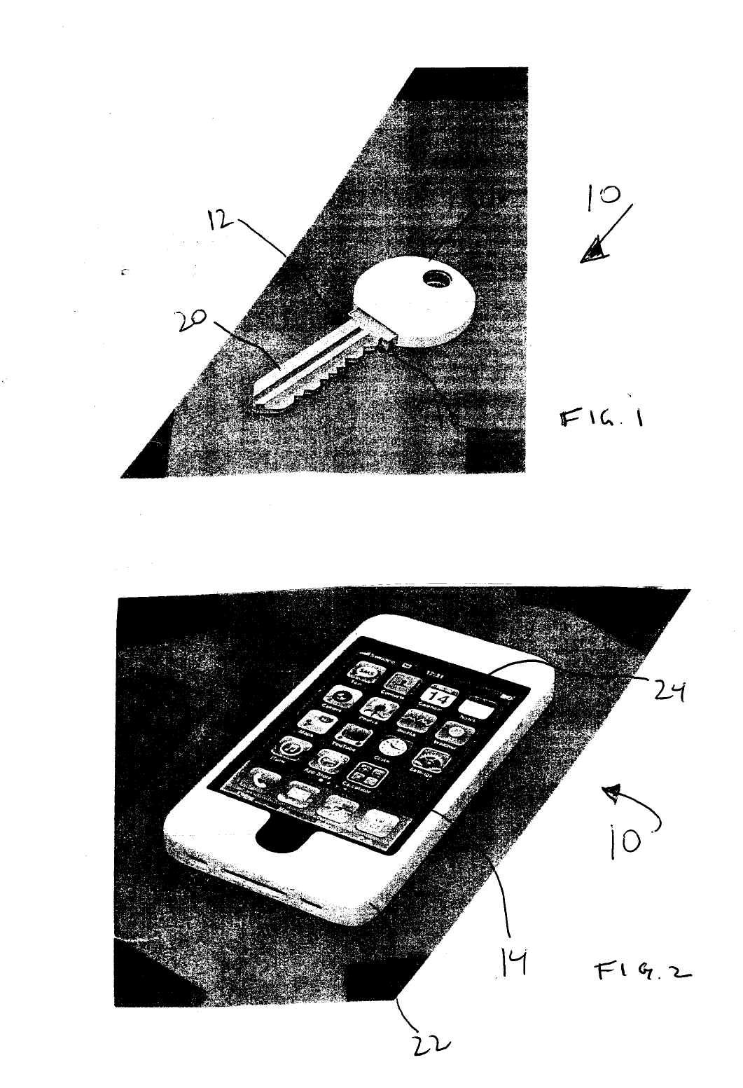

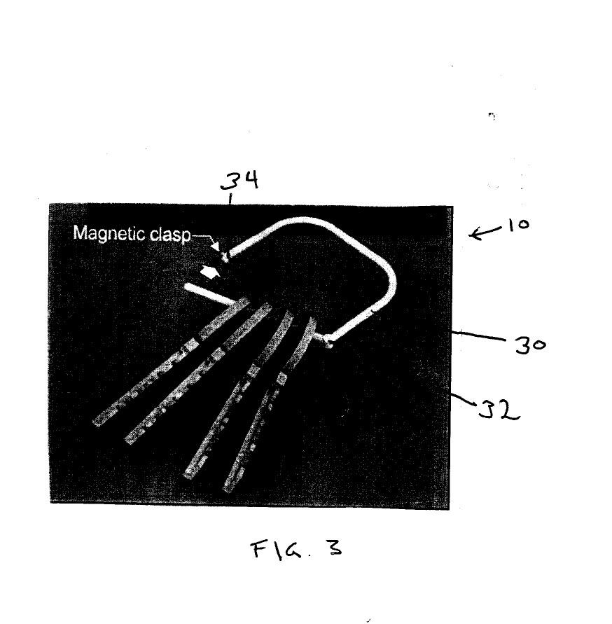

### DETAILED DESCRIPTION OF THE INVENTION

The present invention, hereinafter referred to as the Glowing Cover System, indicated generally at 10, is a specially configured cover for objects that features glow in the dark capabilities. In a preferred embodiment, the Glowing Cover System 10 is useful for keys 12 as well as cell phones 14 and key rings 30 although using the Glowing Cover System 10 for other objects is within the scope of the present invention.

The Glowing Cover System 10 of the present invention provides users with a simple and effective means of locating items when they are misplaced. For instance, the Glowing Cover System 10 provides a visual beacon for quickly locating keys 12 that are difficult to find. The Glowing Cover System's 10 key cover embodiment is preferably circular in shape and fabricated of a durable plastic or rubber material. The Glowing Cover System's 10 key cover embodiment is constructed to sheathe many different types of keys with luminescence. The Glowing Cover System's 10 key ring embodiment is capable of holding multiple keys.

In an embodiment of the Glowing Cover System 10 of the present invention, the key 12 has a bow 16, a shoulder 18, and a shaft 20. Preferably, the Glowing Cover System 10 covers the entire bow 16 of the key 12. In another embodiment, the shoulder 18 and shaft 18 are free from being covered by the Glowing Cover System 10.

The Glowing Cover System 10 of the present invention also includes an embodiment for covering the cell phone 14. In a preferred embodiment, the cell phone embodiment of the Glowing Cover System 10 is rectangular in shape, conforms to the shape of the cell phone 14, and fabricated of a durable plastic or rubber material. The Glowing Cover System's 10 cell phone embodiment is constructed to sheathe many different types of cell phones 14 with luminescence.

In an embodiment of the Glowing Cover System 10 of the present invention, the cell phone 14 has a casing 22 and a screen 24 formed in a front side of the casing 22. Preferably, the Glowing Cover System 10 covers the entire casing 22 of the cell phone 14. In another embodiment, the screen 24 is free from being covered by the Glowing Cover System 10.

In an embodiment of the Glowing Cover System 10 of the present invention, the key ring 30 is a hinged element capable of holding a plurality of keys. Key ring 30 has a hinge 32 and a magnetic clasp 34. When hinge 32 of the key ring 30 is open, keys can be placed on the ring 30, and the hinge 32 is closed, and the ring 30 is secured using magnetic clasp 34.

The luminescent quality of the Glowing Cover System 10 of the present invention is preferably achieved with phosphors that emit a shine in normal lighting yet are especially bright in low lit and dark areas. A phosphor is a substance that radiates visible light after being energized.

The phosphors can either be embedded within the Glowing Cover System 10 or applied to the surface of the Glowing Cover System 10 by means of a paint or ink. As will be understood by those skilled in the art, the preferred means of glowing described herein is merely one way for the Glowing Cover System 10 to glow and that other means and methods of glowing are within the scope of the present invention.

Regardless the time of day or night, the Glowing Cover System 10 of the present invention enables residential or office users to quickly see their keys 12, cell phone 14, or key ring 30 and easily retrieve them. Eliminating fruitlessly digging through chair cushions, crawling on a floor to search underneath furniture, or rooting through crowded purses and backpacks, the Glowing Cover System 10 pinpoints the location of these elusive items in a matter of seconds. As a result, precious minutes are saved on busy days when time is in short supply. For those people who manage multiple keys 12, the key ring 30 of the Glowing Cover System 10 holds up to six keys 12 and is large enough to easily slide around one's thumb or finger. The key ring 30 of the Glowing Cover System 10 is highly functional for janitors, building superintendents, night shift and hospital and hotel workers who can now easily spot their keys 12 in a dark room, closet, cabinet, or storage area. For instance, the energized phosphors can glow in a variety of colors such that with multiple keys 12 each individual key 12 can have a different glowing color or each key 12 can have multiple glowing colors.

Easy to use, one need only sheathe an item with a Glowing Cover System 10 of the present invention. The sheathed item is ensconced in a brilliant glow that is seen readily in any darkened environment and even in normal light. The simplicity and luminescence of the Glowing Cover System 10 is highly effective for use by children, elderly persons and visually impaired individuals. Constructed of durable and high quality materials, the Glowing Cover System 10 will withstand years of continued use.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A glowing cover system for illuminating an object, the glowing cover system comprising:
a cover capable of being positioned over at least a portion of the object; and
an amount of phosphors associated with in the cover;
wherein upon energizing the phosphors, the phosphors radiate visible light causing the cover to glow.

2. The glowing cover system of claim 1 wherein the phosphors are embedded in the cover.

3. The glowing cover system of claim 1 wherein the phosphors are applied to an outer surface of the cover.

4. The glowing cover system of claim 3 wherein the phosphors are contained within a paint or ink embellished with phosphors.

5. The Glowing Cover System of claim 1 wherein the cover is sized and shaped for covering at least a portion of a key.

6. The Glowing Cover System of claim 5 wherein the key has a bow, a shoulder, and a shaft, the cover covering the entire bow of the key.

7. The Glowing Cover System of claim 6 wherein the shoulder and shaft are free from being covered by the cover.

8. The Glowing Cover System of claim 1 wherein the cover is sized and shaped for covering at least a portion of a cell phone, the cover conforming to a shape of the cell phone.

9. The Glowing Cover System of claim 8 wherein the cell phone has a casing and a screen formed in a front side of the casing, the cover covering the entire casing of the cell phone.

10. The Glowing Cover System of claim 9 wherein the screen is free from being covered by the cover.

11. The Glowing Cover System of claim 1 wherein the cover is constructed from a material selected from plastic and rubber.

12. The Glowing Cover System of claim 1 wherein the energized phosphors provides a visual beacon for quickly locating the object.

13. The Glowing Cover System of claim 1 wherein the energized phosphors can glow in a variety of colors.

14. The Glowing Cover System of claim 13 and further comprising:
multiple keys;
wherein each individual key has a different glowing color.

15. A method for illuminating an object, the method comprising:
providing a cover;
positioning at least a portion of the cover over the object;
associating an amount of phosphors with in the cover;
energizing the phosphors; and
radiating visible light from the phosphors causing the cover to glow.

16. A glowing cover system for illuminating an object, the glowing cover system comprising:
a cover capable of being positioned over at least a portion of the object;
an amount of phosphors associated with in the cover;
wherein upon energizing the phosphors, the phosphors radiate visible light causing the cover to glow;
wherein the energized phosphors can glow in a variety of colors; and
wherein the energized phosphors provide a visual beacon for quickly locating the object.

17. The glowing cover system of claim 16 wherein the phosphors are embedded in the cover.

18. The glowing cover system of claim 16 wherein the phosphors are applied to an outer surface of the cover.

19. The glowing cover system of claim 18 wherein the phosphors are contained within a paint or ink embellished with phosphors.

20. The glowing cover system of claim 16 wherein each cover contains multiple colors of glowing phosphors.
